(19) United States
(12) Patent Application Publication
(10) Pub. No.: US 2018/0000105 A1
(43) Pub. Date: Jan. 4, 2018

(54) NON-DAIRY COTTAGE CHEESE AND METHOD OF PRODUCTION

(71) Applicant: HUMAN NATURE LTD., Tel-Aviv (IL)

(72) Inventors: Adi Yehezkeli, Tel-Aviv (IL); Adi Langiel, Tel-Aviv (IL)

(21) Appl. No.: 15/622,083

(22) Filed: Jun. 14, 2017

(30) Foreign Application Priority Data
Jun. 15, 2016 (IL) 246249

(51) Int. Cl. A23C 20/02

(52) U.S. Cl. CPC A23C 20/025; A23V 2002/00; A23V 2200/12

(57) ABSTRACT

The invention describes a non-dairy cottage cheese composition, having a curded texture, comprising about 1% to about 20% of nuts, seeds or soybeans; and about 60% to about 98% water. The invention additionally describes a method of production thereof.

### FIELD

This invention relates generally to cottage cheese, and more specifically to non-dairy cottage cheese, and methods of producing the same.

### BACKGROUND

Non-dairy products became popular not only for people who are lactose-intolerant but also for those who choose to become vegan. Vegans preclude from their diet, animal meat and products made from animal sources, such as milk, cheeses etc.

Nowadays, the cheese equivalents industry currently offers a variety of non-dairy cheeses made of soy or nuts as their primary ingredients to replace dairy cheeses made from whey. These cheeses are categorized as: soft and spreadable cheese equivalents, half-hard cheese equivalents and hard cheese equivalents. These cheese equivalents are typically manufactured using one the following methods:
(1) addition of casein or caseinates protein designed to replace the whey. However the casein or caseinates used in the industry are of animal source resulting in a non-vegan cheese product.
(2) addition of different type of starches into water or milk-equivalents and oil. This mixture is then molded using a variety of stabilizers.
(3) replacing dairy whey with different types of nuts. In some cases, yeast is used to accelerate the ripening process of these nut-based cheeses.

None of the current cheese equivalents has a curded texture, which is commonly known as a “cottage cheese”.

Generally speaking, dairy cottage cheese is made from mixing liquid ingredients together with cheese grains. This type of cheese is very popular among dairy cheese consumers. However, no parallel non-dairy cottage cheese is offered to vegan or lactose-intolerant consumers.

Moreover, non-dairy cheese is of higher nutritional value, as compared to a dairy cheese, because the non-dairy cheese has low amounts of saturated fats, lactose, certain allergies and cholesterol.

In light of the above, the need exists for a non-dairy equivalent for cottage cheese that has a desirable taste, flavor, mouth feel (gritty or grainy texture) and shelf life. The need also exists for a process and non-dairy cottage cheese resulting from use of that process, in which the cottage cheese product can be manufactured in an industrial form.

These and other features and advantages of the present invention will be explained and will become apparent through the description of the.

### SUMMARY OF THE INVENTION

The present disclosure is directed to a non-dairy cottage cheese, having a curded texture and methods of producing the same. In particular embodiments, the non-dairy cottage cheese comprises, in various compositions, nuts, seeds, soybeans and water. In other embodiments the non-dairy cottage cheese may also comprise, in various compositions, oil, salt and/or sugar. The non-dairy cottage cheese is manufactured by providing a liquid phase and a solid phase. The final composition of the cottage cheese is set by the given compositions of the solid phase and the liquid phase by way of weighted average. In particular embodiments, the liquid phase comprises, in various compositions, water or non-dairy milk based on nuts or seeds or soybeans, oil, salt and sugar. In particular embodiments, the solid phase comprises non-dairy hard cheese equivalents or half-hard cheese equivalents. Other ingredients which may optionally be added to the liquid phase or to the solid phase comprise food colorings, flavorings, stabilization materials, starches preservatives or fermenting bacteria.

Two versions of the method for producing non-dairy cottage cheese are disclosed herein. In accordance with a particular embodiment of the present disclosure, one version of the method comprises blending all ingredients of a liquid phase to form a homogeneous mass, then blending said liquid phase together with the solid phase to a mixture and lastly grinding said mixture until obtaining a curd mixture comprising soft non-dairy cheese curds, preferably at a size of about 2 mm to about 7 mm. The second version of method comprises blending all ingredients of a liquid phase to form a homogeneous mass, then grinding the solid phase until obtaining a curded mixture comprising soft non-dairy cheese curds, preferably at a size of about 2 mm to about 7 mm and lastly blending said grainy mixture together with the liquid phase to a mixture. In both versions all stages are performed at room temperature.

Advantages of particular embodiments of the present disclosure include creating a non-dairy cheese with curded texture, having the flavor and characteristics of the parallel dairy cheese, known as “cottage cheese”. The known prior art does not offer a non-dairy cheese with similar characteristics. Moreover, because the present cottage cheese is non-dairy product, it is suitable for vegan consumers and lactose-intolerant. Additionally, this product has also low amounts of saturated fats, certain allergies and cholesterol.

Other advantages of the present disclosure will be readily apparent to one skilled in the art from the following description and claims. Moreover, while specific advantages have been enumerated above, various embodiments may include all, some or none of the enumerated advantages.

### DETAILED DESCRIPTION

Unless otherwise stated, all percentages herein are weight percentages.

As used herein the term “cottage cheese” is intended to refer to a cheese equivalent having curds, namely a gritty or grainy texture. The texture is similar to that obtained by coagulating milk, however the ingredients are primarily non-dairy, or include only minute traces of dairy (low dairy).

In the present invention, the terms “non-dairy cottage”, and “cottage cheese equivalent” are used interchangeably.

Particulars embodiments disclosed herein include a non-dairy cheese having a desirable taste, flavor and texture similar to dairy cottage cheese, and a method for producing the same. Other particulars embodiments disclosed herein include producing nut or seed based cottage cheese that may be entirely free of dairy ingredients and method for producing the same. Additionally, particular embodiments include nut or seed based cottage cheese that may be partially free of dairy ingredients, and a method for producing the same.

The term “nut” as used herein generally refers to any type of human-edible dry fruit composed of a separable hard shell or rind and an interior kernel, whereas the kernel of the nut is the part used in the production process. Non-limiting examples are: hickory, hazel nuts, pecans, almonds, peanuts, pistachios, macadamia nuts, coconut, walnuts, cashews, Brazil nuts, chestnuts, pine nuts, etc. The nut content may be added in the form of a nut butter.

Non-limiting examples “seeds” as used herein is generally refer to watermelon seeds, melon seeds, sunflower seed, hemp, sesame, oat etc.

As noted above, the present invention refers to a non-dairy cottage cheese that is essentially free of dairy proteins or any other dairy products. Thus, a preferred composition has 0% dairy proteins. The dairy-free cottage cheese is suitable for vegan consumers or highly-allergic consumers, for instance lactose intolerant consumers

In a particular embodiment, a general process of making the cottage cheese equivalent, is by mixing together a liquid phase (described herein-below) with a solid phase (described below), and then grinding until grains of about 2 mm to about 7 mm are obtained. The product is then refrigerated at a temperature of 4° C. The production process is executed at room temperature.

In one embodiment, the ratio between the liquid phase and the solid phase of the non-dairy cottage cheese is as follows:
Liquid phase about 20% to about 80%;
Solid phase about 80% to about 20%.

The preferred liquid phase is a combination of about 0% to about 97% water or a non-dairy liquid made of nuts, and/or seeds and/or soybeans.

The preferred liquid phase further comprises about 3% to about 20% oils, about 0% to about 10% salt and about 0% to about 10% sugar.

Common types of oil that may be used include non-hydrogenated oils, such as margarine, as well as fats and oils from corn, sesame, olive, soybeans, coconut, sunflower, safflower, cottonseed, palm and rapeseed. All will hereinafter be referred to as “oil”.

Common types of sugar that may be used include white sugar, brown sugar, granulated sugar, caster sugar, confectioner sugar, cane sugar, demerara sugar, turbinado sugar, muscovado sugar and artificial sugar (all type of sweeteners). All will hereinafter be referred to as “sugar”.

Optionally, the preferred liquid phase may also comprise additional components that are well known and selected based on subjective preferences, namely food colorings, flavorings, stabilization materials, preservatives, and/or fermenting bacteria typically used in the cheese industry, such as Lactobacillus acidophilus, Streptococcus thermophilus, etc.

In one embodiment, the present invention will use said additional components up to levels of about 0% to about 5% of the liquid phase composition.

The preferred solid phase is comprised of neutral-flavored non-dairy hard cheese equivalents or half-hard cheese equivalents. The preparation and formulation of such a non-dairy cheese is conventional and well-known to those of ordinary skill in the art. Typically, the present invention will use a cheese equivalent comprising non-dairy mozzarella, etc.

Optionally, the preferred solid phase may also comprise additional components that are well known and selected based on subjective preferences, namely stabilization materials and preservatives, such as Sulfur dioxide (commercially known as E220), Sorbat salt, Bisulfite (commercially known as E222), Formic acid or Benzoic acid Bisulfite (commercially known as E210), synthetic antioxidant additives, or any other know preservation additives typically used in the food industry; flavorings, starches, food colorings, fermenting bacteria typically used in the cheese industry, such as Lactobacillus acidophilus, Streptococcus thermophilus, etc. In one embodiment, the present invention will use said additional components up to levels of about 0% to about 5% of the liquid phase composition.

In one embodiment of the invention, the preparation process is as follows. Unless otherwise stated, all stages are performed at room temperature. All the ingredients of the liquid phase are first blended together to form a homogeneous mass. Then the liquid phase is blended together with the solid phase. The mixture is inserted into a grinder, and ground until soft grains of about 2 mm to about 7 mm are obtained. The grainy mixture which is retained is referred herein as cottage cheese. The cottage cheese may be filled into containers in various volumes for use by the end consumers. The final cottage cheese is then refrigerated at a temperature of 4° C.

In another embodiment of the invention, first the solid phase is solely inserted into a grinder while grinding until soft grains in size of about 2 mm to about 7 mm are obtained. Then after, the liquid phase is added to the grainy mass and blended therewith to form a grainy mixture. The grainy mixture is referred herein as cottage cheese. The cottage cheese may be filled into containers in various volumes for use by the end consumers. The final cottage cheese is then refrigerated at a temperature of 4° C.

The preferred composition of the final cottage cheese is about 1% to about 20% of nuts, seeds or soybeans, about 60% to about 98% of water, about 0% to about 30% of oil, about 0% to about 3% of salt, and about 0% to about 3% of sugar.

These and other aspects of the present invention may be more fully understood by reference to the following example:

### EXAMPLE

A non-dairy cottage cheese style is made according to the following composition: In this example the total weight of the liquid phase and the total weight of the solid phase are equal.

Liquid Phase Composition:

| | |
|---|---|
| Non-dairy liquid made of soybeans, | 92% |
| comprising of water, soybeans and salt | |
| Purified coconut oil | 8% |
| Salt and sugar | less than 3% |

Solid Phase Composition:

| | |
|---|---|
| Non-dairy liquid made of soybeans, | 85% |
| comprising of water, soybeans and salt | |
| Purified coconut oil | 8% |
| Tapioca | 5% |
| Stabilization materials (kappa carrageenan, Guar Gum) | 2% |
| Salt | ~0% |

The composition of the final cottage cheese which retained from the above provided liquid and solid phases is as follows:

| | |
|---|---|
| Non-dairy liquid made of soybeans, | 88.5% |
| comprising of water, soybeans and salt | |
| Purified coconut oil | 8% |
| Tapioca | 2.5% |
| Stabilization materials (kappa carrageenan, Guar Gum) | 1% |
| Salt and sugar | less than 3% |

The preferred composition of the final cottage cheese is calculated based on weighted average between the solid phase ingredients and the liquid phase ingredients according to their weight percentages. The weight percentage of each ingredient is multiplied by the actual weight of the liquid phase or of the solid weight respectively. The sum of this contribution is then divided by the total weight of the liquid and the solid phases.

According to the above example the total weight of the liquid phase and the total weight of the solid phase are equal. For instance, the weight of each phase is herein defined as 1 kg. Thus, the composition of the non-dairy liquid in final cottage cheese is calculated by: (1*92%+1*85%)/2=88.5%, the composition of the Tapioca starch is calculated by: (1*0%+1*5%)/2=2.5% and so on.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-dairy cottage cheese composition, having a curded texture, comprising:
about 1% to about 20% of nuts, seeds or soybeans; and
about 60% to about 98% water.

2. The non-dairy cottage cheese composition of claim 1, further comprising:
about 0% to about 30% of oil;
about 0% to about 3% of salt; and
about 0% to about 3% of sugar.

3. The non-dairy cottage cheese composition of claim 1, comprising:
a) about 20% to about 80% liquid phase;
wherein said liquid phase is comprising:
i) about 0% to about 97% liquid;
ii) about 3% to about 20% oil;
iii) about 0% to about 3% salt; and
iv) about 0% to about 3% sugar.
b) about 80% to about 20% solid phase;
wherein said solid phase composition comprises non-dairy hard cheese equivalents or half-hard cheese equivalents.

4. The non-dairy cottage cheese composition of claim 1 wherein said nuts are selected from one or more members of the group consisting of: hickory, hazel nuts, pecans, almonds, peanuts, pistachios, macadamia nuts, coconut, walnuts, cashews, Brazil nuts, chestnut and pine nuts.

5. The non-dairy cottage cheese composition of claim 1 wherein said nuts are added in the form of a nut butter.

6. The non-dairy cottage cheese composition of claim 1 wherein said seeds are selected from one or more members of the group consisting of: watermelon seeds, melon seeds, sunflower seed, hemp, sesame and oat.

7. The non-dairy cottage cheese composition of claim 2 wherein said oil is selected from the group consisting of: margarine, corn oil, sesame oil, olive oil, soybean oil, coconut oil, sunflower oil, safflower oil, cottonseed oil, palm oil, rapeseed oil, and mixtures thereof.

8. The non-dairy cottage cheese composition of claim 2 wherein the sugar is selected from one or more members of the group consisting of: white sugar, brown sugar, granulated sugar, caster sugar, confectioner sugar, cane sugar, demerara sugar, turbinado sugar, muscovado sugar; and artificial sugar.

9. The non-dairy cottage cheese composition of claim 3 wherein said liquid (i) is selected from the group consisting of: water, non-dairy nut-based milk, non-dairy seed-based milk; and non-dairy soybeans-based milk.

10. The non-dairy cottage cheese composition of claim 3 wherein said liquid phase composition further comprises:
about 0% to about 3% food colorings;
about 0% to about 3% flavorings;
about 0% to about 5% stabilization materials;
about 0% to about 5% preservatives; and
about 0% to about 3% fermenting bacteria.

11. The non-dairy cottage cheese composition of claim 3 wherein said solid phase composition further comprises:
about 0% to about 3% food colorings;
about 0% to about 3% flavorings;
about 0% to about 5% starches;
about 0% to about 3% stabilization materials; and
about 0% to about 2% fermenting bacteria.

12. The non-dairy cottage cheese composition of claim 3, comprising:
88.5% non-dairy liquid made of soybeans, comprising: water, soybeans and salt;
8% purified coconut oil;
2.5% tapioca;
1% stabilization materials; and
less than 3% salt;
wherein the liquid phase composition comprises:
92% non-dairy liquid made of soybeans, comprising: water, soybeans and salt;
8% purified coconut oil; and
about 0% salt and sugar;
and
wherein the solid phase composition comprises:
85% non-dairy liquid made of soybeans, comprising: water, soybeans and salt;
8% purified coconut oil;
5% tapioca;
2% stabilization materials; and
less than 3% salt.

13. A method for producing a non-dairy cottage cheese, the method comprising:
a) blending all ingredients of a liquid phase to form a homogeneous mass;
b) blending said liquid phase together with a solid phase to obtain a mixture; and
c) grinding said mixture until obtaining a curd mixture of soft non-dairy cheese curds.

14. The method of claim 13, wherein said grinding stage is performed before adding said liquid phase, said method comprising:
a) blending all ingredients of a liquid phase to form a homogeneous mass;
b) grinding a solid phase until obtaining a curded mixture comprising soft non-dairy cheese curds; and
c) blending said grainy mixture together with the liquid phase to a mixture.

15. The method of claim 13, wherein the grinding stage is performed until obtaining soft curds at a size of about 2 mm to about 7 mm.

16. The method of claim 13, wherein all stages are performed at room temperature.
